(19) United States
(12) Patent Application Publication
(10) Pub. No.: US 2025/0014769 A1
(43) Pub. Date: Jan. 9, 2025

(54) OVERPACK CASK FOR REMOVABLY RECEIVING, HANDLING AND TRANSPORTING A REPOSITORY CONTAINER FOR SPENT NUCLEAR MATERIAL

(71) Applicant: Kernkraftwerk Gösgen-Däniken AG, Däniken (CH)

(72) Inventors: Leo ORNOT, Oberentfelden (CH); Marcel RIEKER, Niedergösgen (CH); Franz STROHMER, Bamberg (DE)

(21) Appl. No.: 18/708,716

(22) PCT Filed: Nov. 10, 2022
(86) PCT No.: PCT/EP2022/081423

§ 371 Date: May 9, 2024

(30) Foreign Application Priority Data
Nov. 12, 2021 (EP) 21208056.8

(51) Int. Cl. G21F 5/12; G21F 5/005

(52) U.S. Cl. CPC G21F 5/12; G21F 5/005

(57) ABSTRACT

An overpack cask for reversibly receiving, handling and transporting a repository container for spent nuclear material is disclosed, and the overpack cask comprises a tubular cask shell defining a receiving cavity for reversibly receiving a repository container therein, a first cask cover providing a sealing closure of the receiving cavity at a first axial end of the tubular cask shell and a second cask cover providing a sealing closure of the receiving cavity at a second axial end of the tubular cask shell opposite to the first axial end. At least the first cask cover is removable from the tubular cask shell to uncover a first opening of the tubular cask shell at the first axial end for loading and/or unloading a repository container into and from the receiving cavity, respectively.

### FIELD OF THE INVENTION

The present invention relates to an overpack cask for reversibly receiving, handling and transporting a repository container for spent nuclear material, in particular a repository container for long-term storage of spent nuclear material.

### BACKGROUND ART

Spent nuclear material, such as spent fuel assemblies, has to be isolated from the human habitat for a very long time period until its radioactivity has decayed to a harmless level. For this, deep geological repositories are foreseen where the waste is enclosed in a tight and stable rock formation at a depth of several hundred meters. The spent nuclear material cannot be simply stored unpackaged in the deep geological repository, but will be loaded beforehand into special repository containers for long-term storage, for example, in a high-level waste encapsulation plant or an underwater packaging facility. These repository containers themselves provide only modest shielding of radioactive gamma and neutron radiation. Hence, for internal transport purposes as well as for the transport on public routes and the final transport into the deep geological repository an overpack cask will be required that is capable of receiving and transporting such a repository containers, whilst shielding the strong, radioactive gamma and neutron radiation of the spent fuel material contained therein. Preferably, it is also desired that the overpack cask enables improved handling of the repository containers, in particular for service work, such as for sealing the repository containers, for drying the interior of the overpack cask and for quality assurance of the closure lid weld used to finally seal the containers.

Currently, overpack casks suitable for these purposes are not available since the transport of repository containers loaded with nuclear material for long-term storage will not be necessary until the first commissioning of encapsulation plants and deep geological repositories. Up to now, spent fuel assemblies have been directly loaded, transported and stored temporarily for many years, e.g., in so-called type-B casks with GGVS (Gefahrgutverordnung Strasse)/ADR (accord europeen relatif au transport international de marchandises dangereuses par route) approval for international transport, such as CASTOR (cask for storage and transport of radioactive material) containers or casks from other manufacturers. However, such conventional fuel casks are not suitable for the above purposes. A major reason for this is that the length of a repository container for spent fuel assemblies itself is already longer than those conventional fuel casks. Another reason is that any future overpack cask must allow easy unloading of the repository container therefrom in the gallery of the deep geological repository.

Therefore, it is an object of the present invention to provide an overpack cask for reversibly receiving and transporting a repository container for spent nuclear material, in particular a repository container for long-term storage of spent nuclear material, wherein the overpack container is intended to allow easy unloading of the repository container in the gallery of a deep geological repository and preferably also improved handling of the repository container for service work.

### DESCRIPTION OF THE INVENTION

This object is achieved by an overpack cask according to independent claim 1. Further features and advantageous aspects of the overpack cask are subject of the dependent claims.

According to the present invention, there is provided an overpack cask for reversibly receiving, handling and transporting a repository container for spent nuclear material. The overpack cask comprises a tubular cask shell defining a receiving cavity for reversibly receiving a repository container therein, a first cask cover providing a sealing closure of the receiving cavity at a first axial end of the tubular cask shell, and a second cask cover providing a sealing closure of the receiving cavity at a second axial end of the tubular cask shell opposite to the first axial end. At least the first cask cover is removable from the tubular cask shell to uncover a first opening of the tubular cask shell at the first axial end for loading and/or unloading a repository container into and from the receiving cavity, respectively. Furthermore, the overpack cask comprises a sliding guide arrangement arranged at an inner circumferential side of the tubular cask shell for slidingly guiding and supporting a repository container during loading and unloading the repository container into and from the receiving cavity, and when the repository container is received in the receiving cavity.

Advantageously, the tubular cask shell and the first and second cask covers together form a safe shielding of a repository container received therein, which shields gamma and neutron radiation sufficiently well to allow safe transport of the repository container, if necessary also on public transport routes, in accordance with the legal requirements.

The receiving cavity defined by the tubular cask shell preferably has a length extension between the very inner end faces of the first and second cask covers (as measured along a length axis of tubular cask shell) that is chosen large enough for receiving a repository container having a length of about 5.27 meters. For example, the length extension between the very inner end faces of the first and second cask covers may be at least 5.30 meters. Preferably, the length extension between the very inner end faces of the first and second cask covers may be adaptable, as will be described in more detail further below. Likewise, the receiving cavity preferably has an inner diameter (as measured in a radial direction perpendicular to the length axis of tubular cask shell) that is chosen large enough for receiving a repository container having an outer diameter of about 1.05 meters. For example, an inner diameter of the receiving cavity, in particular between the inner most extensions of the sliding guide arrangement (more particularly, the inner diameter of a receptacle defined by the sliding guide arrangement, in particular by the guiding members of the sliding guide arrangement) is in a range between 1.05 meters and 1.30 meters. Vice versa, an outer diameter of the overpack cask, in particular an outer diameter of the tubular cask shell preferably does not exceed a diameter of approximately 2.50 meters, because the dimensions of the galleries of deep geological repositories, as they are planned so far, do not allow for larger outer diameters. That is, an outer diameter of the overpack cask, in particular an outer diameter of the tubular cask shell preferably is at most 2.50 meters, in particular at most 2.40 meters. For example, the outer diameter of the tubular cask shell may be range between 1.00 meter and 2.50 meters, in particular between 1.40 meter and 1.80 meters.

Preferably, the tubular cask shell is a monolithic body, in particular made of nodular cast iron. A monolithic body provides particularly high mechanical stability and good shielding properties, in particular when made of nodular cast iron. Likewise, the first and second cask covers, or at least parts thereof, such as at least one of a primary, a secondary and a tertiary flange plate of the first and second cask covers (see below) may be a monolithic body, in particular made of stainless steel.

An outside of the tubular cask shell may comprise a plurality of cooling fins which improve the dissipation of decay heat power originating from the spent nuclear material enclosed in the overpack cask and facilitates the keep the outside of the overpack cask at modest temperatures. Alternatively, if the thermal load of the overpack is low, the outside of the tubular cask shell may be smooth, e.g. it can consist of an electropolished layer of Nickel or Chromium coating, which protects the cask material against corrosion and offers an easy decontamination of the surface. Advantageously, a smooth outside, e.g. as achieved with electropolishing process, is easier to decontaminate.

In addition, the overpack cask may comprise one or more neutron moderator elements, preferably in the forms of one or more neutron moderator rods and/or one or more neutron moderator plates. The one or more neutron moderator elements, in particular the one or more neutron moderator rods and/or plates, may be embedded in the tubular cask shell. For example, the overpack cask may comprise one or more neutron moderator rods embedded in the tubular cask shell and extending along the length axis of the tubular cask shell. A neutron moderator is a medium that reduces the speed of fast neutrons, ideally without capturing any, leaving them as thermal neutrons with only minimal (thermal) kinetic energy. The material that can be used in the overpack may be high density polyethylene or high-density polypropylene or any other polymer with has a high content of hydrogen atoms. As such, the one or more neutron moderator elements advantageously help to reduce the neutron radiation exposure outside the overpack cask.

The first cask cover being removable from the tubular cask shell allows for loading a repository container via the uncovered first opening into the receiving cavity, both under dry conditions in a high-level waste encapsulation plant or in wet condition under water, e.g. in an underwater packaging facility. Preferably, a repository container is loaded into the receiving cavity via the first opening when the overpack cask is in an upright position, with a length axis of the tubular cask shell extending in a substantially vertical direction and the first opening being at the top. Further advantageous aspects of the removable first cask cover will be described further below.

While it is preferred that the overpack cask is in an upright position when loading a repository container into the overpack cask, unloading of a repository container from the overpack cask in the upright position will be difficult to implement in a deep geological repository due to the limited dimensions below ground in the galleries of the deep geological repository. Therefore, according to the present invention it has been found that for unloading of a repository container the overpack cask preferably is in a lying position with the length axis of the tubular cask shell extending transverse, in particular perpendicular to a height extension of the gallery, more particularly with the length axis of the tubular cask shell extending in a substantially horizontal direction.

In order to facilitate the process of unloading or loading a repository container from or into the overpack cask, in particular when the overpack cask is in a lying position, but also when the overpack cask is in an upright position, the overpack container according to the present invention comprises a sliding guide arrangement which is arranged at an inner circumferential side of the tubular cask shell and configured for guiding and supporting a repository container during loading it into and unloading it from the receiving cavity, and when it is received the receiving cavity. Advantageously, the sliding guide arrangement provides a low-friction unloading/loading process in both, the upright position and the lying position of the overpack cask, thus ensuring that the repository container does not suffer any damage on its outside. As such, the sliding guide arrangement is configured to receive a repository container and to support and guide a movement of the repository container into and out of the overpack cask along a length axis of the tubular cask shell. Preferably, the sliding guide arrangement is also configured to support and hold a repository container received in the overpack cask in a direction perpendicular to a length axis of the tubular cask shell, i.e. in the radial direction. In particular, the sliding guide arrangement may define a receptacle within the receiving cavity for holding the repository container when received in the receiving cavity. Thus, the sliding guide arrangement is configured to fix the repository container around the central length axis of the overpack cask, so that during transport the repository container cannot move in an uncontrolled manner and cannot exert dynamic forces against the inner wall of the overpack cask. This is particularly important for transport operations in order to protect the repository container and the nuclear material contained therein in the event of accidents, such as drops.

To facilitate the movement of a repository container along a length axis of the tubular cask shell when loading or unloading the repository container into or from the overpack cask, the sliding guide arrangement may comprise a plurality of guiding members. For example, the plurality of guiding members may comprise one or more of cylindrical rollers, biconcave rollers, biconvex rollers, linear bearings, sliding rods or ball bearings, and linear ball bearings. Preferably, the rollers are arranged such that a contact surface of each roller extends in a direction circumferentially tangent to an outside of the repository container at the contact point or contact line between the repository container and the respective roller.

The plurality of guiding members may be configured to bias against an outer surface of the repository container, in particular when the repository container is at least partially received in the sliding guide arrangement, even more particularly when the repository container is fully received in the sliding guide arrangement. Due to this biasing, the repository container is fixed around the central length axis of the overpack cask such that it cannot move in a direction perpendicular to the length axis of the overpack cask, for example during transport.

The sliding guide arrangement may be realized as an insert allowing to equip the overpack cask with different sliding guide arrangements having different inner diameters such that the overpack cask is adaptable to receive repository containers of different dimensions. As such, the insert preferably is reversibly arranged at the inner circumferential side of the tubular cask shell. Thus, the insert may be easily exchanged by another one having a different inner diameter. Preferably, the insert extends circumferentially and in the axial direction substantially completely over the entire inner circumferential side of the tubular cask shell. In particular, the insert may extend substantially from the first axial end to the second axial end of the tubular cask shell.

The insert may comprise one or more insert sleeves or one or more insert cages. In this configuration, the interior of the one or more insert sleeves or the one or more insert cages define a receptacle within the receiving cavity of the tubular cask shell for receiving the repository container therein. The plurality of guiding members may be arranged in a plurality of axially spaced groups of ring assemblies, wherein the guiding members in each ring assembly are distributed-preferably annularly uniformly-along the inner circumferential side of the tubular cask shell. As used herein, the term “axially spaced” refers to a spaced arrangement of the ring assemblies along the length axis of the tubular cask shell. In particular, the guiding members in each ring assembly may be distributed along the inner circumferential side of the one or more insert sleeves described above. For example, each ring assembly may comprise 3, 4, 5, 6, 7, 8, 9 or 10 guiding members distributed—preferably annularly uniformly—along the inner circumferential side of the tubular cask shell. Likewise, the plurality of guiding members may be arranged in a plurality of linear assemblies which extend along the length axis of the tubular cask shell and are distributed—preferably annularly uniformly—at the inner circumferential side of the tubular cask shell, wherein each linear assembly comprises a plurality of guiding members arranged in line parallel to the length axis of the tubular cask shell. For example, the sliding guide arrangement may comprise 4, 5, 6, 7, 8, 9 or 10 linear assemblies of guiding members extending along the length axis of the tubular cask shell and being distributed—preferably annularly uniformly—at the inner circumferential side of the tubular cask shell. An annularly uniform distribution of the guiding members or of the linear assemblies of guiding members, respectively, proves particularly advantageous with respect to a symmetric guidance and support, in particular fixation, of the repository container in a direction perpendicular to the length axis of the tubular cask shell. Furthermore, the annularly uniform distribution allows to load and/or unload a repository container into or from the overpack cask in any rotational position of the overpack cask with respect to the length axis of the tubular cask shell, in particular when the overpack cask is in a lying position, such as an essentially horizontal position.

In general, the first cask cover may comprise one or more flange plates, in particular a flange plate system of at least two flange plates, preferably three flange plates. The various flange plates may have a different sealing systems for sealing connection to the first axial end, in particular to a first flange mount of the tubular cask shell at the first axial end.

More particularly, the first cask cover may comprise a primary flange plate for sealing connection to a first flange mount of the tubular cask shell at the first axial end. Furthermore, the first cask cover may comprise a secondary flange plate for sealing connection to the first flange mount of the tubular cask shell on top of the primary flange plate of the first cask cover. In addition, the first cask cover may optionally comprise a tertiary flange plate for sealing connection to the first flange mount of the tubular cask shell on top of the secondary flange plate of the first cask cover. The first flange mount at the first axial end of the tubular cask shell may comprise a double or triple stepped sealing profile. Each profile step is configured to sealingly engage with one of the primary flange plate, the secondary flange plate and the tertiary flange plate of the first cask cover.

Like the first cask cover, the second cask cover may also be removable from the tubular cask shell to uncover a second opening of the tubular cask shell at the second axial end for loading and/or unloading a repository container into and from the receiving cavity, respectively. The removable second cask cover and the second opening are preferably used for unloading a repository container from the receiving cavity, when the overpack cask is in a lying position, in particular below ground in a deep geological repository.

Upon having removed the second cask cover, a repository container received within the overpack cask may be pulled out of the receiving cavity via the second opening. Alternatively, the repository container received within overpack cask may be pushed out of the receiving cavity via the second opening by means of an ejection member entering the receiving cavity at the first axial end. The latter is preferred since pushing out—in contrast to pulling out—does not require to attach any removal tools to the repository container, and thus facilitates a remote and automated removal of the repository container from the overpack cask. For pushing out, the first cask cover may be removed or at least partially removed such as to provide access for the ejection member. For this, the first cask cover, in particular the primary flange plate of the first cask cover, may comprise a through-hole, in particular a central through-hole, and a removable closure lid providing a sealing closure of the through-hole. As used herein, the term “central through-hole” refers to a through-hole the center of which is in line with a central length axis of the tubular cask shell when the first cask cover is attached to the first axial end of the tubular cask shell. The through-hole—when the closure lid is removed therefrom—is configured for passing an ejection member (preferably not part of the overpack cask), such as a plunger, therethrough. The ejection member may be used for displacing a repository container received in the receiving cavity in a direction along the length axis of the tubular cask shell. In particular, ejection member may be used for pushing a repository container received in the receiving cavity out of the receiving cavity via the second opening at the second axial end. Thus, the repository container can be easily unloaded from the overpack cask in a remote and automated manner without complete removal of the primary flange plate from the overpack cask. This is of particular benefit since no person has to work in the direct radiation field of the repository container.

The through-hole may comprise a sealing profile, in particular a double stepped or triple stepped sealing profile. Likewise, the closure lid may comprise a corresponding sealing profile, in particular a correspondingly stepped sealing profile. This configuration allows for a particularly safe closure of the receiving cavity. The closure lid may be attached to the remainder of the first cask cover, in particular to the primary flange plate of the first cask cover, by screw fitting.

As kind of additional equipment, the overpack cask may comprise a guide sleeve which is configured to be attached to the through-hole, when the closure lid is removed therefrom. The guide sleeve is configured for guiding the ejection member along the length axis of the tubular cask shell as well as for protecting the through-hole, in particular the sealing profile of the through-hole, when the ejection member passes through the through-hole. The guide sleeve may be configured to match the sealing profile of the through-hole, preferably the innermost step of the double stepped or triple stepped sealing profile. Like the closure lid, the guide sleeve may also be attached to the remainder of the primary flange plate by screw fitting. The inner diameter of the guide sleeve preferably corresponds to the outer diameter of the ejecting member such as to provide a safe guidance. The guide sleeve may be realized as a wear part. In particular, the guide sleeve may be made of soft metal, such as bronze or brass. After pushing out the repository container, the guide sleeve can be removed again and the closure lid can be reinstalled.

Similar to the first cask cover, the second cask cover may also comprise one or more flange plates, in particular a flange plate system of at least two flange plates, preferably three flange plates. Like for the first cask cover, the various flange plates of the second cost cover may have a different sealing systems for sealing connection to the second axial end, in particular to a second flange mount of the tubular cask shell at the second axial end.

More particularly, the second cask cover may comprise a primary flange plate for sealing connection to a second flange mount of the tubular cask shell at the second axial end. Furthermore, the second cask cover may comprise a secondary flange plate for sealing connection to the second flange mount of the tubular cask shell on top of the primary flange plate of the second cask cover. In addition, the second cask cover may optionally comprise a tertiary flange plate for sealing connection to the second flange mount of the tubular cask shell on top of the secondary flange plate of the second cask cover. Like the first flange mount at the first axial end, the second flange mount at the second axial end of the tubular cask shell may comprise a double or triple stepped sealing profile. Each profile step is configured to sealingly engage with one of the primary flange plate, the secondary flange plate and the tertiary flange plate of the second cask cover.

Since the repository container is slidingly supported by the sliding guide arrangement when received in the overpack cask, it must be ensured that during transport-when the overpack cask typically is in a lying, in particular horizontal position, the repository container cannot roll back and forth between the first cask cover and the second cask cover. For this, the second cask cover, in particular the primary flange plate of the second cask cover, may comprise at least one spring-loaded pressure plate configured to bias (i.e. to generate a biasing force) against a repository container received in the receiving cavity in a direction towards the first axial end. Thus, especially when the overpack cask is in a lying position, the repository container may be safely fixed between the first cask cover and the second cask cover, in particular between the primary flange plate of the first cask cover and the primary flange plate of the second cask cover.

For generating the biasing force, the second cask cover, in particular the primary flange plate of the second cask cover may comprise one or more spring elements, such as 1, 2, 3, 4, 5, or 6 spring elements, which exert a restoring spring force onto the pressure plate in a direction towards the first axial end. As used herein, the term “spring element” refers to an elastic element capable of storing mechanical energy. For example, the one or more spring elements may comprise one of a spiral spring, a plate spring, a disk spring, a flat spring, a leaf spring, a gas pressure spring, and an oil pressure spring.

Preferably, the expansion length of the one or more spring elements is chosen large enough such as to compensate for differences in length between different repository containers of a specific type. Such differences in length may be due, for example, to welding processes used to finally seal the repository containers.

Differences in length may also be compensated by replacing the pressure plate by another pressure plate having a different dimension, in particular thickness, along the length axis of the tubular cask cover when being installed. For this, the pressure blade may be removably mounted in the overpack cask.

In addition, the second cask cover, in particular the primary flange plate of the second cask cover, may comprise one or more stop elements providing an abutment for the one or more pressure plates to limit a movement of the one or more pressure plates in a direction towards the second axial end. Preferably, the one or more stop elements are configured and arranged such that when the one or more pressure plates abut against the one or more stop elements a contact surface being in contact with the repository container is flush with the axially innermost surface of the remainder of the second cask cover, in particular the axially innermost surface of the remainder of the primary flange plate of the second cask cover facing the first axial end. Advantageously, the stop elements thus provide an improved force distribution over the entire second cask cover, in particular the entire primary flange plate of the second cask cover, in the event of high load exposure towards the second axial end. For example, the stop element may be an annular a ring-shaped stop element.

The one or more spring elements, in particular the spring constant of the one or more spring elements may be chosen to exert a specific restoring spring force with respect to the specific repository container to be received within overpack cask such that on the one hand, when the overpack cask is in an upright position, in particular in a vertical position, the weight of the repository container received in the repository container suffice to compress the pressure plate against the one or more stop elements, and that on the other hand, when the overpack cask is in a lying position, in particular in a horizontal position, such as during transport, the repository container is pressed against the first cask cover, in particular the primary flange plate of the first cask cover. The one or more spring elements may be exchangeable, in particular removably mounted in the overpack cask, for replacing them by one or more other spring elements having a different spring force, thus allowing to adapt the overpack cask to repository containers of different weights.

The second cask cover, in particular the primary flange plate of the second cask cover, may be configured to cooperate with a mounting pivot arm for disassembling and re-assembling the second cask cover, in particular the primary flange plate from and to the second flange mount of the tubular cask shell in a pivot movement. Advantageously, the pivot movement facilitates the disassembling and re-assembling of the second cask cover, in particular of the primary flange plate, in the cramped confines of a deep geological repository. In addition, the mounting pivot arm allows for a (fully) automated and remote disassembling and re-assembling of the second cask cover, in particular the primary flange plate. This proves advantageous since no person has to work in the direct radiation field of the repository container. The second cask cover, in particular the primary flange plate of the second cask cover, may comprise a plurality of tapped blind holes configured and arranged to attach the mounting pivot arm to the second cask cover, in particular the primary flange plate, by bolted fastening. The plurality of tapped blind holes may be arranged at an outer surface of the secondary cask cover, in particular an outer flange surface of the primary flange plate of the second cask cover, facing away from the first axial end. For disassembling, the mounting pivot arm may be configured to first retract the second cask cover, in particular the primary flange plate of the second cask cover, from the second axial end along a certain distance along the length axis of the tubular cask shell (for example 30 centimeter), and then to swivel the second cask cover, in particular the primary flange plate of the second cask cover, aside by at least 90 degrees. In this configuration, the second opening of the tubular cask shell at the second axial end is fully cleared, so that the repository container can be freely loaded into or unloaded from the receiving cavity. For (re-) assembling of the second cask cover, in particular the primary flange plate of the second cask cover, to the second axial end, the movement sequence of the mounting pivot arm is reversed.

The sealing connection of one or more of the primary flange plate, the secondary flange plate and the tertiary flange plate of the first cask cover and the second cask cover to the first flange mount and the second flange mount, respectively, may comprises a metal profile seal connection. For this, the primary flange plate, the secondary flange plate and the tertiary flange plate of the first cask cover and the second cask cover and a corresponding portion of the first flange mount and the second flange mount, respectively, may comprise correspondingly formed sealing profiles which are sealingly pressed to each other, preferably by bolting the respective flange plate and the respective flange mount of the tubular cask shell together. Metal profile gaskets suffice the legal requirements for a safe closure of transport casks for nuclear material. Accordingly, the sealing connection of one or more of the primary flange plate, the secondary flange plate and the tertiary flange plate of the first cask cover and the second cask cover to the first flange mount and the second flange mount, respectively, may comprise a bolted metal profile seal connection.

The sealing connection of one or more of the primary flange plate, the secondary flange plate and the tertiary flange plate of the first cask cover and the second cask cover to the first flange mount and the second flange mount, respectively, may also comprise a bayonet joint. In particular, the bayonet joint may be used to close secure the metal profile seal connection, i.e. to sealingly press the correspondingly formed sealing profiles of a respective flange plate and flange mount together. Advantageously, a bayonet joint allows the flange plates to be installed and de-installed quickly, in particular in a remote and automated manner. This proves advantageous in reducing the time spent in the radiation field of the overpack cask and thus reduces the radiation exposure of the operating personnel. A bayonet joint for connecting the primary flange plate is of particular benefit as it allows for quickly closing the receiving cavity with the primary flange plate which already provides a major shielding effect. For GGVS/ADR transports, the integrity of the closures must be achieved in accordance with Type B. This may require the flange plates to be secured by means of a bolted connection in addition to the bayonet connection. Hence, the bayonet joint preferably is in addition to a bolted connection, such as a bolted metal profile seal connection.

As kind of another additional equipment, the overpack cask may comprise a working attachment configured to be detachably attached to the first axial end of the tubular cask shell, when the first cask cover is removed therefrom. The working attachment may comprise receptacles for engagement with (temporarily mountable) lateral trunnions of a repository container in order to hold the repository container in a service position in which the repository container is partially inserted into the overpack cask through the first opening. That is, the working attachment prevents the repository container from being completely loaded into the receiving cavity of the overpack cask in that the (temporarily mountable) lateral trunnions of the repository container rest in the receptacles of the working attachment. This position may be used as a service position, e.g. for welding, grinding and testing work to be carried out in at the sealing cover of the repository container. The working attachment protects the first axial end of the tubular cask shell, in particular the first flange mount flange in order to ensure that after holding a container in the service position the first opening can be still properly closed by the first cask cover in a permanently gas-tight manner.

Preferably, the working attachment is a multipart working attachment comprising at least two ring segments. Even more preferably, the at least two ring segments are separated from each other to form gaps therebetween in a circumferential direction of the ring segments. The (circumferential) gaps may provide a fluid communication between the interior and the surrounding of the overpack cask when a repository container is hold in the service position. A fluid communication may be important for drying the interior of the overpack cask when a repository container is resting in the working position on the work attachment. Drying may be necessary since the repository container-when loaded into the working attachment—may be still wet on its outside upon having been loaded with spent nuclear material in an underwater packaging facility. In particular, the (circumferential) gaps between adjacent ring segments may be configured such that a device for drying the interior of the overpack cask may be installed therein.

The working attachment may comprise a support frame which the at least two ring segments are mounted/mountable, in particular reversibly mounted/mountable on. As such, the support frame holds the at least two ring segments together and thus facilitates the installation and de-installation of the working attachment on and from the first axial end of the tubular cask shell. Having the at least two ring segments being reversibly mountable on the support frame enables to de-install the support frame when the at least two ring segments are installed on the first axial end of the tubular cask shell, and to re-install the support frame when the working attachment is to be removed again from the first axial end after completion of the service work on the repository container.

The work attachment may comprise one or more attachment points at the support frame, such as eye bolts. After completion of the service work, e.g. after sealing the repository container, the repository container can be lifted with a crane, for example by attaching it to a trunnion on the top cover of the repository container, and the temporarily mounted lateral trunnions of the repository container can be de-installed, in particular by remote handling. The repository container may then be loaded completely in the overpack cask and the work attachment may be removed by a crane after being attached to the support frame.

The working attachment, in particular each ring segment, may comprise a base part for engagement with the first axial end of the tubular cask shell, in particular with the first flange mount, and a bearing part on top of the base part for engagement with the repository container to be hold in the service position. This bipartite setup of the working attachment or the ring segments allows to independently adapt the respective contact portions of the working attachment with the first axial end and the repository container to their respective purpose of use. In particular, the bipartite setup of the working attachment or the ring segments allows to use different materials for the bearing part and the base part. That is, the bearing part and the base part may be made of different materials. Preferably, the bearing part comprises or is made of metal, in particular stainless steel. In contrast, the base part preferably comprises or is made of high-density radiation proof plastic, for example high-density polyethylene or high-density polypropylene.

In particular, the base part may comprise a protective layer or protective coating forming at least a portion of the base part that engages, in particular gets into contact with the first axial end of the tubular cask shell, in particular with the first flange mount, when the working attachment is attached to the first axial end of the tubular cask shell. The protective layer or protective coating may comprise or may be made of high-density radiation proof plastic, for example high-density polyethylene or high-density polypropylene. Likewise, protective layer or protective coating may comprise or may be made of an elastic material, such as rubber. The base part, in particular the protective layer or protective coating, advantageously protects the first axial end, in particular the first flange mount during the loading of a repository container. More particularly, the specific materials mentioned may help to prevent damages, in particular scratching of the sealing surfaces of the first axial end, in particular the first flange mount, when the working attachment is attached to the first axial end of the tubular cask shell.

The base part may comprise a docking flange mount having a profile complementary to a profile of the first flange mount of the tubular cask shell. This setup and provides a fixed, secure, and stable support for the repository container in the service position.

Furthermore, the base part may comprise at least two, in particular at least three positioning pins. The positioning pins may be arranged and configured for engagement with corresponding positioning holes at the first axial end, in particular at the first flange mount of the tubular cask shell. Alternatively, the base part may comprise a positioning ring or at least two, in particular at least three positioning pins which are arranged and configured for engagement with outer circumference of a rim of the first axial end, in particular the first flange mount such as to fix the position of the working attachment in the radial direction when it is attached to the first axial end of the tubular cask shell. Advantageously, the positioning pins or the position rings and—if present—the corresponding positioning holes facilitate a proper positioning of the working attachment relative to the overpack cask during its installation and thus prevents the first axial end, in particular the first flange mount of the tubular cask shell from damages which otherwise could occur if the working attachment gets into contact with the overpack offset from its predetermined position.

The positioning pins or the position rings may comprise or may be made of metal, in particular stainless steel. Alternatively, the positioning pins or the position rings may comprise or may be made of radiation proof, preferably high-density plastic, for example polyethylene or polypropylene, in particular high-density polyethylene or high-density polypropylene.

### BRIEF DESCRIPTION OF THE DRAWINGS

FIG. 1 shows a cross-sectional view of an exemplary embodiment of an overpack cask according to the present invention with a repository container received therein;

FIG. 2 shows a cross-sectional view of the overpack cask according to FIG. 1, with the repository container partially unloaded therefrom;

FIG. 3-4 show details of the sliding guide arrangement implemented in the overpack cask according to FIG. 1;

FIG. 5 shows details of a bayonet joint used to close the cask covers of the overpack cask according to FIG. 1;

FIG. 6 shows details of the second cask cover of the overpack cask according to FIG. 1 and a mounting pivot arm for disassembling and re-assembling the second cask cover;

FIG. 7 shows details of the first cask cover of the overpack cask according to FIG. 1 and a guide sleeve mounted thereto;

FIG. 8 shows an exemplary embodiment of a working attachment configured to be detachably attached to the overpack cask according to FIG. 1; and

FIG. 9 shows a cross-sectional view of the overpack cask according to FIG. 1 with the working attachment according to FIG. 8 attached thereto.

### DETAILED DESCRIPTION OF EMBODIMENTS

An exemplary embodiment of the present invention is now described with reference to the drawings, wherein like reference numerals are used to refer to like elements throughout.

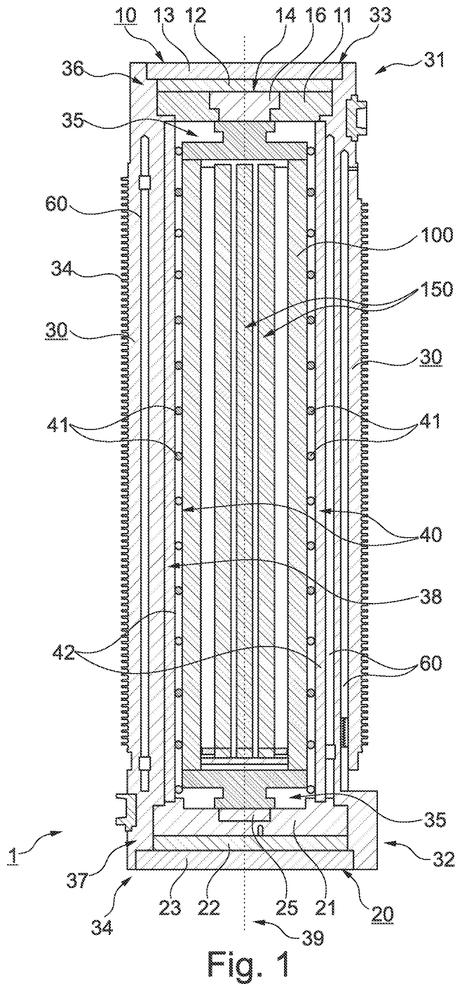

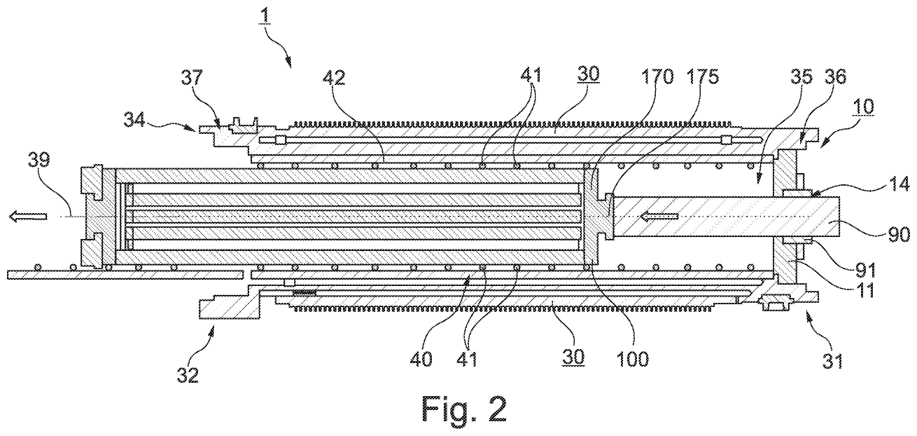

FIG. 1 shows a cross-sectional view of an exemplary embodiment of an overpack cask 1 according to the present invention which is configured for removably receiving, handling and transporting a repository container 100 for spent nuclear material 150, for example, for long-term storage of spent fuel assemblies. The overpack cask 1 comprises a tubular cask shell 30 defining a receiving cavity 35 for reversibly receiving the repository container 100 therein. The overpack cask 1 further comprises a first cask cover 10 providing a sealing closure of the receiving cavity 35 at a first axial end 31 of the tubular cask shell 30, as well as a second cask cover 20 providing a sealing closure of the receiving cavity 35 at a second axial end 32 of the tubular cask shell 30 opposite to the first axial end 31. The first cask cover 10 is removable from the tubular cask shell 30 to uncover a first opening 33 of the tubular cask shell 30 at the first axial end 31 for loading and/or unloading the repository container 100 into and from the receiving cavity 35, respectively. Preferably, the first opening 33 is primarily used to load a repository container 100 into the receiving cavity 35, in particular when the overpack cask 1 is in an upright position with a length axis 39 of the tubular cask shell 30 extending in a substantially vertical direction. In the present embodiment, the second cask cover 20 is also removable from the tubular cask shell 30 to uncover a second opening 34 of the tubular cask shell 30 at the second axial end 32 which also allows for loading and/or unloading a repository container 100 into and from the receiving cavity 35, respectively. Preferably, the second opening 34 is primarily used to unload a repository container 100 from the receiving cavity 35, in particular by pushing the repository container 100 out of the receiving cavity 35 using an ejection member entering the receiving cavity 35 via the first axial end 31. This will be described in more detail further below with respect to FIG. 2. The tubular cask shell 30 as well as the first and second cask covers 10, 20 together form a safe shielding of the repository container 100 received therein, which shields gamma and neutron radiation sufficiently well to allow safe transport of the repository container in accordance with the legal requirements.

In the present embodiment, the receiving cavity 35 defined by the tubular cask shell 30 has a length extension along the length axis 39 between the very inner end faces of the first and second cask covers 10, 20 as well as an inner diameter which are chosen to be sufficiently large to receive a repository container 100 having a length of about 5.27 meters and an outer diameter of about 1.05 meters. The total length extension of the overpack cask 1 shown in FIG. 1 as measured between the very ends of the first and second axial ends 31, 32 is about 5.94 meters. In contrast, the outer diameter of the tubular cask shell 30 is at most 2.50 meters, because the dimensions of the galleries of deep geological repositories, as they are planned so far, do not allow for larger outer diameters. For example, the outer diameter of the tubular cask shell 30 may be range between 1.00 meter and 2.50 meters, in particular between 1.40 meter and 1.80 meters.

In the present embodiment, the tubular cask shell 30 is a monolithic body made of nodular cast iron which provides particularly high mechanical stability and good shielding properties. The first and second cask covers 10, 20 (more precisely their various components) also comprise monolithic bodies made of stainless steel. As can be further seen in FIG. 1, the outside of the tubular cask shell 30 comprises a plurality of cooling fins which improve the dissipation of decay heat power originating from the spent nuclear material 150 enclosed in the overpack cask 1 and thus facilitate the keep the outside of the overpack cask 1 at modest temperatures. To reduce the neutron radiation exposure outside the overpack cask 1, the overpack cask 1 shown in FIG. 1 comprises a plurality of neutron moderator elements 60 in the forms of neutron moderator rods and neutron moderator plates embedded in the tubular cask shell 30.

According to the present invention, it has been found that due to the expectedly cramped confines of future deep geological repositories unloading of the repository container 100 from the overpack cask 1 in a deep geological repository will probably only be possible when the overpack cask 1 is in a lying, substantially horizontal position. In order to facilitate the unloading process in the lying, substantially horizontal position, the overpack cask 1 according to the present invention comprises a sliding guide arrangement 40 which is arranged at an inner circumferential side 38 of the tubular cask shell 30. The sliding guide arrangement 40 is configured for guiding the repository container 100 during unloading it from and loading it into the receiving cavity 35. In addition, the sliding guide arrangement 40 is configured for supporting, in particular for radially fixing the repository container 100 around the central length axis 39 of the overpack cask 1 when it is received in the receiving cavity 35, in particular during transport.

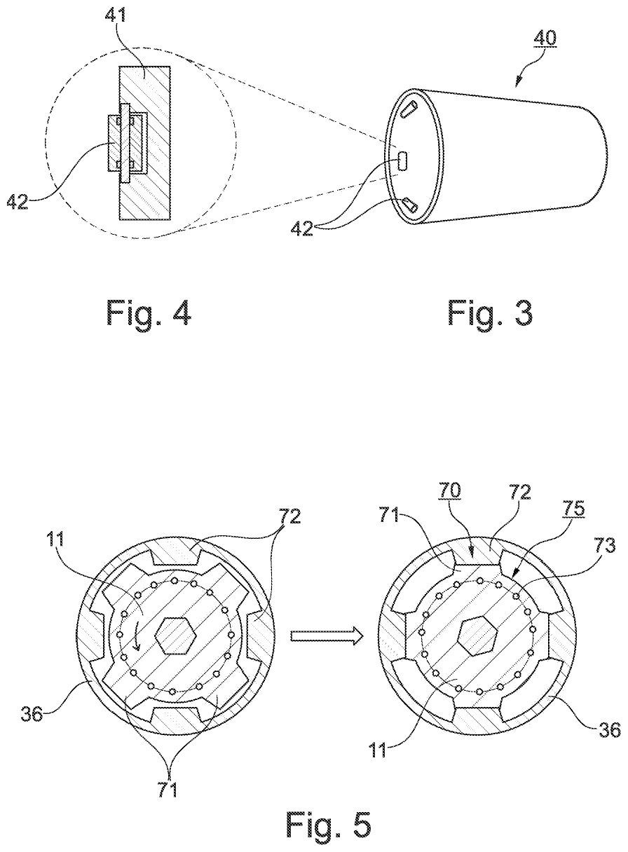

In the present embodiment, the sliding guide arrangement 40 is realized as an insert comprising an insert sleeve 42 with a plurality of guiding members 41, details of which are shown FIG. 3 and FIG. 4. The insert sleeve 42 and the guiding members 41 together form a receptacle within the receiving cavity 35 for receiving the repository container 100 therein, as illustrated in FIG. 1 and FIG. 2. With reference to FIG. 3 and FIG. 4, the guiding members 41 of the sliding guide arrangement 40 are realized as cylindrical rollers which are arranged at an inner circumferential side of the insert sleeve 42 such that a contact surface of each roller extends in a direction circumferentially tangent to an outside of the repository container 100 at the contact point or contact line between the repository container 100 and each roller. As can be further seen in FIG. 3 and FIG. 4, the guiding members 41 are arranged in a plurality of axially spaced groups of ring assemblies. The guiding members 41 in each ring assembly are arranged such as to be distributed annularly uniformly along the inner circumferential side 38 of the tubular cask shell 30, more precisely along the inner circumferential side of the insert sleeve 42. The cylindrical rollers support and guide a low-friction movement of the repository container 100 along the length axis 39 of the tubular cask shell 30. This is not only of particular benefit for unloading/loading the repository container 100 in the lying position of the overpack cask 1, but also for unloading/loading in the upright position of the overpack cask 1. In both positions, the sliding guidance of the repository container 100 ensures that the repository container 100 does not suffer any damage on its outside.

The plurality guiding members 41 are arranged and configured such that basically each guiding member biases against the outside of the repository container 100 or is at least close to or almost in contact with the outside of the repository container 100. Due to this and due to the uniform distribution of the guiding members 41 over the inner circumferential side of the insert sleeve 42, the sliding guide arrangement 40 also supports and holds the repository container 100 when being received in the overpack cask 1 in a direction perpendicular to the length axis 39 of the tubular cask shell 30, i.e. in the radial direction. Thus, the sliding guide arrangement 40 safely fixes the repository container 100 around the central length axis 39 of the overpack cask 30. Advantageously, this prevents the repository container 100 from moving in the radial direction in an uncontrolled manner and from exerting dynamic forces against the inner circumferential side 38 of the tubular cask shell 30 which is particularly important for transport operations in order to protect the repository container 100 and the nuclear material 150 contained therein in the event of accidents.

Again with reference to FIG. 1, the first cask cover 10 and the second cask cover 20 each comprise a flange plate system of three flange plates which are mounted in consecutive order to the first and second flange mounts 36, 37 at the first and second axial end 31, 32 of the tubular cask cover 30, respectively. Both, the first flange mount 36 and the second flange month 37 have a triple stepped seating profile. The first cask cover 10 comprises a primary flange plate 11 forming an innermost closure of the first opening 33. The first cask cover 10 is configured for sealing connection to the innermost profile step of the first flange mount 36 at the first axial end 31. In addition to that, the first cask cover 10 comprises a secondary flange plate 12 for sealing connection to the intermediate profile step of the first flange mount 36 on top of the primary flange plate 11. Finally, the first cask cover comprises a (optional) tertiary flange plate 13 for sealing connection to the outermost profile step of the first flange mount 36 on top of the secondary flange plate 12 of the first cask cover 10. Upon installation, an outer flange plate surface of the tertiary flange plate 13 is flush with the axial end face of the tubular cask shell 30 at the first axial end 31.

Likewise, the second cask cover 20 comprises a primary flange plate 21 forming an innermost closure of the second openings 34. The second cask of the 20 is configured for sealing connection to the innermost profile step of the second flange mount 37 at the second axial end 32. The second cask cover 20 also comprises a secondary flange plate 22 for sealing connection to the intermediate profile step of the second flange mount 37 on top of the primary flange plate 21, as well as a (optional) tertiary flange plate 23 for sealing connection to the outermost profile step of the second flange mount 37 on top of the secondary flange plate 22. Similar to the tertiary flange plate 13 of the first cask cover 10, an outer flange plate surface of the tertiary flange plate 23 of the second cask cover 20 is also flush with the axial end face of the tubular cask shell 30 at the second axial end 32 upon installation.

In the present embodiment, the sealing connections of the primary flange plates 11, 21, the secondary flange plates 12, 22 and the tertiary flange plates 13, 23 of the first and second cask covers 10, 20 to the first and the second flange mounts 36, respectively, comprise a bolted metal profile seal connection. In addition, the sealing connections each comprise a bayonet joint used to closely secure the respective profile seal connection. Details of the bolted metal profile seal connection and the bayonet joint 70 used to connect the primary flange plate 11 of the first cask cover 10 to the first flange mount 36 are shown in FIG. 5. In the bayonet joint 70 according to FIG. 4, connection between the flange plate 11 and the flange mount 36 is achieved by first pushing the flange plate 11 onto the flange mount 36, and by subsequently rotating the flange plate 11 relative to the flange mount 11 around the central length axis 39 of the overpack cask 1 such that lock arms 71 of the flange plate 11 extending radially outward engage with correspondingly formed lock arms 72 of the flange mount 36 extending radially inward. Thereby, the correspondingly formed sealing profiles of the flange plate 11 and flange mount 36 are sealingly pressed together. The other flange plates 12, 13, 21, 22, 23 may comprise similar a bayonet joint to be sealingly connected to the respective flange mounts 36, 37. Advantageously, a bayonet joint allows the flange plates 11, 12, 13, 21, 22, 23 to be installed and de-installed quickly, in particular in a remote and automated manner. This proves advantageous in reducing the time spent in the radiation field of the overpack cask and thus reduces the radiation exposure of the operating personnel. A bayonet joint for connecting the primary flange plates 11, 21 is of particular benefit as it allows for quickly closing the receiving cavity 35 with the primary flange plates 11, 21 which already provides a major shielding effect. For transport purposes, legal requirements may put higher demands on the integrity of the closures. Therefore, in addition to the bayonet joint 70, the flange plates 11, 12, 13, 21, 22, 23 may need to be additionally secured by means of a screw bolts 76 in order to provide a bolted metal profile seal connection 75.

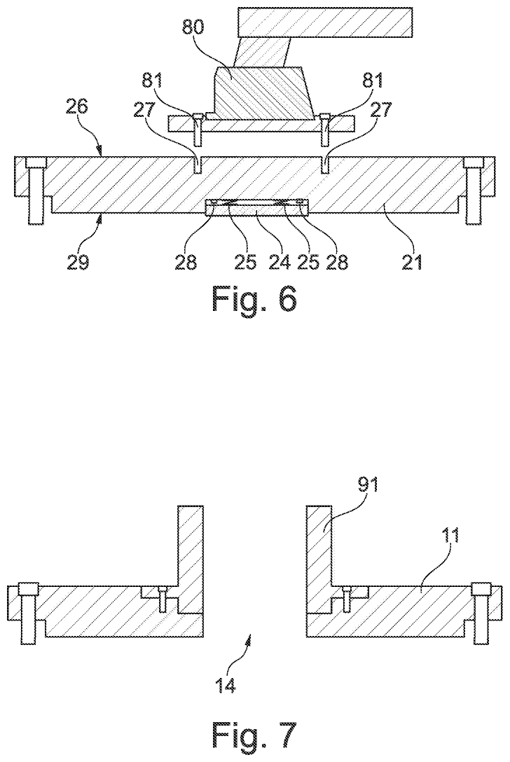

Since the repository container 100 is slidingly supported by the sliding guide arrangement 40 when received in the overpack cask 1, it must be ensured that during transport-when the overpack cask 100 typically is in a lying position, the repository container 100 cannot roll back and forth between the first cask cover 10 and the second cask cover 20. For this, the overpack cask 1 according to the present embodiment comprises a spring-loaded pressure plate 25—as part of the primary flange plate 21 of the second cask cover 20—which is configured to bias (i.e. to generate a biasing force) against the repository container 100 in a direction towards the first axial end 31 such as to safely fix the repository container 100 between the primary flange plate 11 of the first cask cover 10 and the primary flange plate 21 of the second cask cover 20. Details of the spring-loaded pressure plate 24 are shown in FIG. 6. For generating the biasing force, the primary flange plate 21 comprises a plurality of spring elements 25 exerting a restoring spring force onto the pressure plate 24 in a direction towards the first axial end 31. In addition, the primary flange plate 21 comprises a ring-shaped stop element 28 providing an abutment for the pressure plate 24 to limit its movement of in a direction towards the second axial end 32. The pressure plate 24, the spring elements 25 and the stop element 28 are arranged at least partially in a recess formed in the inner flange plate surface 29. The stop element 28 is configured and arranged such that a contact surface of the pressure plate 24 being in contact with the repository container 100 is flush with the axially innermost surface of the remainder of the primary flange plate 21, i.e. with the inner flange plate surface 29, when the pressure plate 24 abuts against the stop element 28. Advantageously, the ring-shaped stop element 28 provides an improved force distribution over the entire primary flange plate 21 in the event of high load exposure towards the second axial end 32. The spring elements 25, in particular their spring forces, are chosen with respect to the weight of the specific repository container 100 such that the pressure plate 24 is pressed against the stop element 28 when the overpack cask 1 is in an upright position, whilst the repository container 100 is pressed against the primary flange plate 11 of the first cask cover 10, when the overpack cask 1 is in a lying position, such as during transport. Deviations in the length of a repository container from a nominal length may be compensated by replacing the pressure plate 24 by another pressure plate having a different thickness. For this, the pressure blade 24 preferably is removably mounted in the overpack cask 1. Furthermore, the spring elements 25 may be exchangeable for replacing them by other spring elements having a different spring force, thus allowing to adapt the overpack cask 1 to repository containers of different weights.

As already indicated above, unloading of the repository container 100 below ground in the gallery of a deep geological repository is preferably performed via the second opening 34 when the overpack cask 1 is in a lying, substantially horizontal position. For this, the second cask cover 20 has to be removed from the second axial end 32. In order to remove and reattach the second cask cover 20, in particular the first flange plate 21 of the second cask cover 20 in a remote and automated manner, the second cask cover 20, in particular the primary flange plate 21 is configured to cooperate with a mounting pivot arm for disassembling and re-assembling the second cask cover 20/primary flange plate 21 from and to the second flange mount 37 in a pivot movement. As shown in FIG. 6 with respect to the first flange plate 21 of the second cask cover 20, the primary flange plate 21 comprises a plurality of tapped blind holes 27 arranged at the outer flange plate surface 26 which are configured to attach the mounting pivot arm 80 thereto by means of screw bolts 81. For disassembling, the mounting pivot arm 80—upon having attached to the first flange plate 21—first retracts the primary flange plate 21 from the second axial end 32 along the length axis 39 of the tubular cask shell and then swivels the primary flange plate 21 aside by at least 90 degrees. In this configuration, the second opening 34 is fully cleared, so that the repository container 100 can be freely loaded into or unloaded from the receiving cavity 35. For (re-) assembling of the primary flange plate 21, the movement sequence of the mounting pivot arm 80 is reversed.

Upon having fully removed the second cask cover 20, the repository container 100 received within the overpack cask 1 may be either pulled out via the second opening 34, or alternatively pushed out via the second opening 34 by means of an ejection member 90 entering the receiving cavity 35 at the first axial end 31, as shown in FIG. 2. The latter is preferred since pushing—in contrast to pulling—does not require to mechanically attach any removal tools to the repository container 100. This facilitates a remote and automated removal of the repository container 100 from the overpack cask 1. In order to provide access for the ejection member 90, the primary flange plate 11 of the first cask cover 10 comprises a central through-hole 14 and a removable closure lid 16 providing a sealing closure of the through-hole 14. Upon having removed the tertiary flange plate 13, the secondary flange plate 12 and the closure lid 16, the ejection member 90, such as a plunger, may be inserted along the length axis 39 into the receiving cavity 35 through the through-hole 14 in order to push the repository container 100 out of the receiving cavity 35 via the second opening 34. Thus, the repository container 100 can be easily unloaded from the overpack cask 1 without complete removal of the primary flange plate 11 from the overpack cask 1. As can be seen in FIG. 1 and FIG. 2, the through-hole 14 and the closure lid 16 comprise correspondingly stepped sealing profiles providing a safe closure of the receiving cavity 35. The closure lid 16 may be attached to the remainder of the primary flange plate 11 by screw fitting.

For guiding the ejection member 90 along the length axis 39 as well as for protecting the through-hole 14, in particular its sealing profile, when the ejection member 90 passes therethrough, a guide sleeve 91 may be attached to the through-hole 14, when the closure lid 16 is removed therefrom. As can been seen from FIG. 7, the guide sleeve 91 is configured to match the stepped sealing profile of the through-hole 14. Like the closure lid 16, the guide sleeve 91 may also be attached to the remainder of the primary flange plate 11 by screw fitting. The inner diameter of the guide sleeve 91 corresponds to the outer diameter of the ejecting member 90 such as to provide a safe guidance. Preferably, the guide sleeve is realized as a wear part made of soft metal, such as bronze or brass. Upon having unloaded the repository container 100, the guide sleeve 91 can be removed again and the closure lid 16 can be reinstalled in the through-hole 14 to securely close the receiving cavity 35 again.

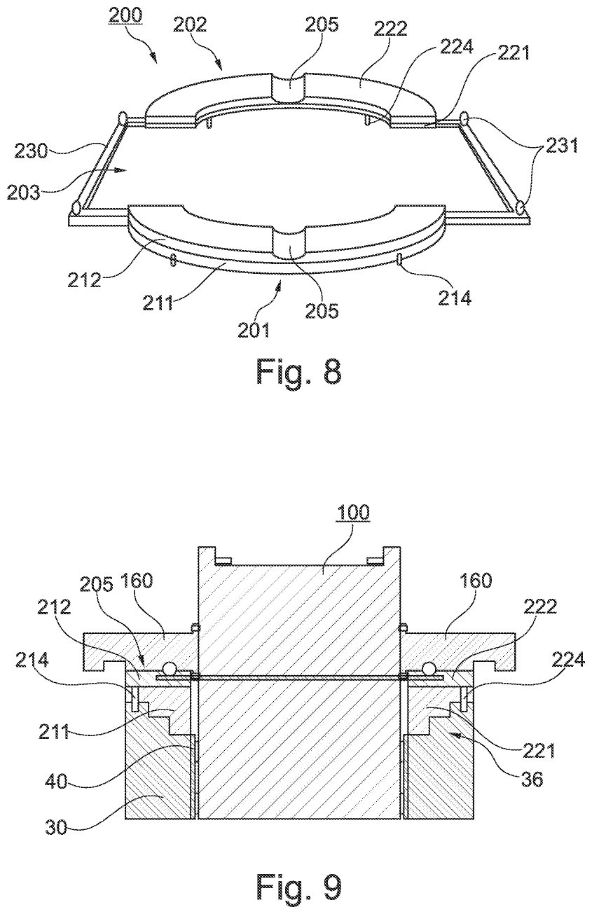

FIG. 8 and FIG. 9 shows an exemplary embodiment of a working attachment 200 which may be an additional equipment of the overpack cask 1 according to FIGS. 1-2 and is configured to be detachably attached to the first flange mount flange 36 at the first axial end 31, when the first cask cover 10 is completely removed therefrom. The working attachment comprises two receptacles 205 for engagement with temporarily mountable lateral trunnions 160 of a repository container 100 in order to hold the repository container 100 in a service position in which the repository container 100 is partially inserted into the overpack cask 1 through the first opening 33, as shown in FIG. 9. This position may be used as a service position, e.g. for welding, grinding and testing work to be carried out at the sealing cover of the repository container 100. Advantageously, the working attachment 200 protects the first flange mount 36 when the repository container 100 rests thereon, thus ensuring that after completion of the service work the first opening 33 can still be properly closed by the first cask cover 10 in a permanently gas-tight manner.

As shown in FIG. 8 and FIG. 9, the working attachment 200 is a multipart working attachment comprising two ring segments 201, 202 separated from each other to form two gaps 203 therebetween in a circumferential direction of the ring segments 201, 202. The circumferential gaps 203 may provide a fluid communication between the interior and the surrounding of the overpack cask 1 when the repository container 100 is hold in the service position. Preferably, the circumferential gaps 203 are configured to mount a device (not shown) for drying the interior of the overpack cask therein. Drying may be necessary since the repository container 100—when loaded into the working attachment—may be still wet on its outside upon having been loaded with spent nuclear material in an underwater packaging facility.

As further shown in FIG. 8, the working attachment 200 comprises a support frame 230 which the two ring segments 201, 202 are reversibly mounted on in order to facilitate the installation and de-installation of the working attachment 200 on and from the first flange mount 36. For this, the work attachment 200 comprises attachment points 231 at the support frame 230, e.g. eye bolts, allowing the support frame to be lifted by a crane. The support frame 230 may be temporarily de-installed when the at least two ring segments 201, 202 rest on the first flange mount 36, and subsequently may be re-installed when the working attachment 200 is to be removed from the first flange mount 36 after completion of the service work.

Each ring segment 201, 202 comprises a base part 211, 221 for engagement with the first flange mount 36, and a bearing part 212, 222 on top of the base part 211, 221 for engagement with the repository container 100 to be hold in the service position. Preferably, the bearing parts 212, 222 are made of metal, in particular stainless steel, while the base parts 211, 221 are made of high-density radiation proof plastic, for example high-density polyethylene or high-density polypropylene. This setup-base parts 211, 221 made of radiation proof plastic, and bearing parts 212, 222 made of metal-protects the first flange mount 36 during the loading of a repository container 100 and provides a fixed, secure, stable support for the repository container 100 in the service position. For this, the base parts 211, 221 comprise a docking flange mount having a profile complementary to the profile of the first flange mount 36, as shown in FIG. 9 (not shown in FIG. 8).

The base parts 211, 221 each comprise two positioning pins 214, 224 made of stainless steel for engagement with corresponding positioning holes at the first flange mount 36 in order to facilitate a proper positioning of the working attachment 200 relative to the overpack cask 1 during its installation. Advantageously, this protects the first flange mount 36 from damages which otherwise could occur if the working attachment 200 gets into contact with the overpack cask 1 offset from its predetermined position.

After completion of the service work, the repository container 100 can be lifted with a crane, for example by attaching it to a trunnion 175 on the top cover 170 of the repository container 100 (shown in FIG. 2). In the lifted position, the temporarily mounted lateral trunnions 160 of the repository container 100 can be de-installed, before the repository container 100 can then be loaded completely in the overpack cask 1 and the work attachment 200 can be removed again by a crane being attached to the support frame 230 at the attachment points 231.

1. An overpack cask for removably receiving, handling and transporting a repository container for spent nuclear material, the overpack cask comprising:
a tubular cask shell defining a receiving cavity for reversibly receiving a repository container therein;
a first cask cover providing a sealing closure of the receiving cavity at a first axial end of the tubular cask shell, wherein the first cask cover is removable from the tubular cask shell to uncover a first opening of the tubular cask shell at the first axial end for loading and/or unloading a repository container into and from the receiving cavity, respectively;
a second cask cover providing a sealing closure of the receiving cavity at a second axial end of the tubular cask shell opposite to the first axial end;
a sliding guide arrangement at an inner circumferential side of the tubular cask shell for guiding and supporting a repository container during loading and unloading the repository container into and from the receiving cavity, and when the repository container is received in the receiving cavity, wherein the sliding guide arrangement is realized as an insert comprising one or more insert sleeves or one or more insert cages, wherein the insert extends circumferentially and in the axial direction substantially completely over the entire inner circumferential side of the tubular cask shell.

2. The overpack cask according to claim 1, wherein the second cask cover is removable from the tubular cask shell to uncover a second opening of the tubular cask shell at the second axial end for loading and/or unloading a repository container into and from the receiving cavity, respectively.

3. The overpack cask according to claim 1, wherein the sliding guide arrangement comprises a plurality of guiding members for facilitating a movement of a repository container along a length axis of the tubular cask shell.

4. The overpack cask according to claim 1, wherein the plurality of guiding members is arranged in a plurality of axially spaced groups of ring assemblies, the guiding members in each ring assembly being distributed annularly uniformly along the inner circumferential side of the tubular cask shell, in particular along the inner circumferential side of the one or more insert sleeves.

5. The overpack cask according to claim 3, wherein the plurality of guiding members comprises one or more of cylindrical rollers, biconcave rollers, biconvex rollers, linear bearings, sliding rods or ball bearings.

6. The overpack cask according to claim 1,
wherein the first cask cover comprises a primary flange plate for sealing connection to a first flange mount at the first axial end of the tubular cask shell, and wherein the first cask cover preferably further comprises a secondary flange plate for sealing connection to the first flange mount at the first axial end of the tubular cask shell on top of the primary flange plate of the first cask cover, and optionally a tertiary flange plate for sealing connection to the first flange mount at the first axial end of the tubular cask shell on top of the secondary flange plate of the first cask cover; and/or
wherein the second cask cover comprises a primary flange plate for sealing connection to a second flange mount at the second axial end of the tubular cask shell, wherein the second cask cover preferably further comprises a secondary flange plate for sealing connection to the second flange mount at the second axial end of the tubular cask shell on top of the primary flange plate of the second cask cover, and optionally a tertiary flange plate for sealing connection to the second flange mount at the second axial end of the tubular cask shell at on top of the secondary flange plate of the second cask cover.

7. The overpack cask according to claim 6, wherein the primary flange plate of the first cask cover comprises a through-hole and a removable closure lid providing a sealing closure of the through-hole, wherein the through-hole when the closure lid is removed therefrom—is configured for passing an ejection member therethrough in order to displace a repository container received in the receiving cavity in a direction along the length axis of the tubular cask shell.

8. The overpack cask according to claim 6, wherein the primary flange plate of the second cask cover comprises at least one spring-loaded pressure plate configured to bias against a repository container received in the receiving cavity in a direction towards the first axial end.

9. The overpack cask according to claim 8, wherein the primary flange plate of the second cask cover comprises one or more spring elements exerting a spring force onto the pressure plate in a direction towards the first axial end.

10. The overpack cask according to claim 6, wherein the primary flange plate of the second cask cover comprises one or more stop elements providing an abutment for the pressure plate to limit a movement of the pressure plate in a direction towards the second axial end.

11. The overpack cask according to claim 6, wherein the primary flange plate of the second cask cover is configured to cooperate with a mounting pivot arm for disassembling and re-assembling the primary flange plate from and to the second flange mount of the tubular cask shell in a pivot movement.

12. The overpack cask according to claim 6, wherein the sealing connection of one or more of the primary flange plates, the secondary flanges plate and the tertiary flange plates of the first cask cover and the second cask cover to the first flange mount and the second flange mount, respectively, comprises a metal profile seal connection, in particular a bolted metal profile seal connection.

13. The overpack cask according to claim 6, wherein the sealing connection of one or more of the primary flange plates, the secondary flanges plate and the tertiary flange plates of the first cask cover and the second cask cover to the first flange mount and the second flange mount, respectively, comprises a bayonet joint.

14. The overpack cask according to claim 1, further comprising a working attachment configured to be detachably attached to the first axial end of the tubular cask shell, when the first cask cover is removed therefrom, wherein the working attachment comprises receptacles for engagement with temporarily mountable lateral trunnions of a repository container in order to hold the repository container in a service position in which the repository container is partially inserted into the overpack cask through the first opening.

15. The overpack cask according to claim 14, wherein the working attachment is a multipart working attachment comprising at least two ring segments, wherein the at least two ring segments are separated from each other to form gaps therebetween in a circumferential direction of the ring segments which provide a fluid communication between the interior and the surrounding of the overpack cask when a repository container is hold in the service position.

16. The overpack cask according to claim 15, wherein the working attachment comprises a support frame which at least two ring segments are mounted on or mountable on.

17. The overpack cask according to claim 14, wherein the working attachment, in particular each ring segment, comprises a base part for engagement with the first axial end, in particular with the first flange mount, of the tubular cask shell, and a bearing part on top of the base part for engagement with the repository container to be hold in the service position.

18. The overpack cask according to claim 17, wherein the base part is made of metal, in particular stainless steel, and/or wherein the bearing part is made of high-density radiation proof plastic, for example high-density polyethylene or high-density polypropylene.

19. The overpack cask according to claim 17, wherein the base part comprises a docking flange mount having a profile complementary to a profile of the first flange mount of the tubular cask shell.

20. The overpack cask according to claim 17, wherein the base part comprises at least two positioning pins for engagement with corresponding positioning holes at the first axial end, in particular at the first flange mount of the tubular cask shell.
